(19) United States
(12) Patent Application Publication
(10) Pub. No.: US 2003/0079037 A1
(43) Pub. Date: Apr. 24, 2003

(54) System and method of serving communities of interest

(76) Inventors: Greg Donnelly, Raleigh, NC (US); Tim Ward, East Sussex (GB); Bill Leslie, Santa Clara, CA (US)

Correspondence Address: Pillsbury Winthrop LLP, Intellectual Property Group, 50 Fremont Street, San Francisco, CA, 94105, US

(21) Appl. No.: 10/045,311

(22) Filed: Oct. 24, 2001

(51) Int. Cl. G06F 15/16

(52) U.S. Cl. 709/232; 709/238

(57) ABSTRACT

A system and method of serving communities of interest (COIs) provide multiple network subscribers with simultaneous access to centrally served contact lists. A plurality of network-based applications may be applied to such centrally served lists. Administrative authorization may be assigned such that lists of valid viewers of a particular COI may be administered to support public access. Presence monitoring functionality may be implemented, apprising authorized viewers of the network connection status or availability of public COI members. Lists of valid modifiers, or administrators, for a particular COI may also be administered; a system and method operative in accordance with the present invention may validate access level or authorization prior to allowing modification of COI data record content.

### BACKGROUND

1. Field of the Invention

Aspects of the present invention relate generally to virtual communities of users in a networked computer system environment, and more particularly to a system and method of providing multiple network subscribers with simultaneous access to centrally served communities of interest.

2. Description of the Related Art

A common feature typically employed in conjunction with conventional networked computer systems allows a computer network subscriber to maintain one or more lists containing data records of information related to “contacts.” The term “contacts” in this sense may refer to personal friends or family members, business associates, professional services representatives or clients, and the like. Many network subscribers categorize the entries of such contact lists in accordance with the relationship to the contact; for example, a “Family” list category may contain contact information for individuals related to the subscriber, whereas a “Business” list category may contain contact information for individuals with whom the subscriber has a professional relationship.

While the utility of such contact lists resides primarily in facilitating access to information associated with other individuals who are accessible through the network, contact lists are generally subscriber-specific. That is, a particular subscriber's contact list is personal and accessible only by that particular subscriber. Even in the case where a global, or networkwide, contact list is maintained by a system administrator, for example, an individual subscriber is generally prohibited from viewing or making use of the information in another subscriber's contact list. Additionally, current technology does not permit centrally served applications or administrative functions to be applied to all the contacts in a contact list simultaneously.

### BRIEF DESCRIPTION OF THE DRAWINGS

FIG. 1 is a simplified high-level block diagram illustrating one embodiment of a network topology including a Virtual Community Network server supporting Communities of Interest.

FIG. 2 is a simplified high-level block diagram illustrating embodiments of private and publicly accessible Communities of Interest which may be maintained and served by a Virtual Community Network server.

FIGS. 3A and 3B are simplified high-level block diagrams illustrating the general relationship between elements of one embodiment of a Community of Interest.

FIG. 4 is a simplified flow diagram illustrating the general operational flow of one embodiment of a method of serving Communities of Interest in a Virtual Community Network environment.

### DETAILED DESCRIPTION

Embodiments of the present invention overcome various shortcomings of traditional network subscriber methodologies, providing multiple network subscribers with simultaneous access to centrally served contact lists, or Communities of Interest (COIs). A plurality of network-based applications and administrative functions may be applied to such centrally served lists.

In accordance with one aspect of the present invention, for example, a system and method of serving public COIs may include administrative functionality as well as user applications. Lists of valid, or authorized, viewers of a particular COI may be administered to support public access. Additionally or alternatively, lists of valid modifiers, or administrators, for a particular COI may be administered; in an embodiment allowing modification of COI content, validation of access level may be employed such that authorization may be confirmed when a subscriber attempts to update COI content.

In some embodiments, for example, a system and method of serving publicly accessible COIs may implement presence monitoring functionality, apprising authorized viewers of the network connection status (i.e. the network activity or availability) of COI members.

The foregoing and other attendant aspects of the various embodiments of the present invention will be apparent through examination of the following detailed description thereof in conjunction with the accompanying drawings.

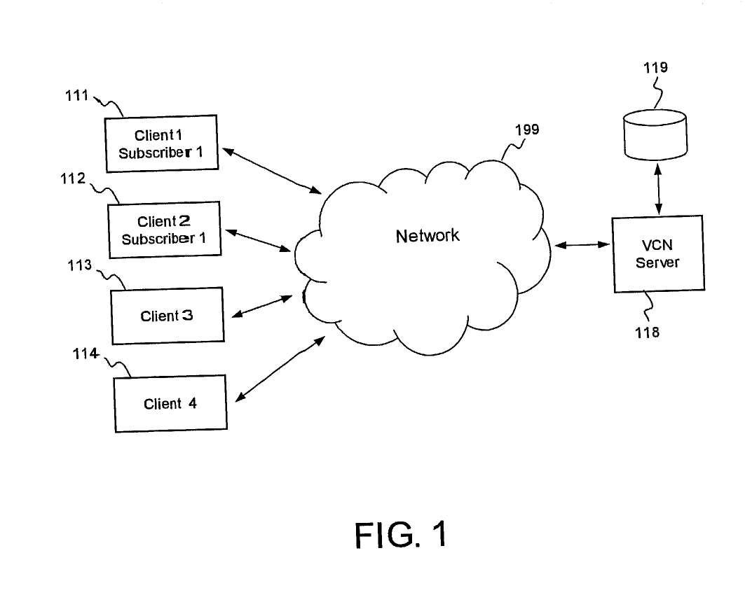

Turning now to the drawings, FIG. 1 is a simplified high-level block diagram illustrating one embodiment of a network topology including a Virtual Community Network (VCN) Server supporting centrally-served Communities of Interest (COIs). In an exemplary network architecture such as depicted in FIG. 1, VCN server 118 may be connected to clients 111-114 through a network 199.

Network 199 may be any communication network known in the art, including the Internet, a local area network (LAN), a wide area network (WAN), a virtual private network (VPN), or any similarly operating system linking network clients 111-114, servers such as VCN server 118, and similarly capable equipment. Network 199 may be configured to facilitate packet-switched data transmission of text, audio, video, Voice over Internet Protocol (VoIP), multimedia, and other data formats known in the art. It will be appreciated that network 199 may employ any topology known in the art such as, for example, star, ring, bus, or any combination thereof.

Additionally, network 199 may generally be configured to operate in accordance with any of the various networking protocols known in the art, such as Transmission Control Protocol (TCP), Internet Protocol (IP), Hypertext Transfer Protocol (HTTP), Simple Mail Transfer Protocol (SMTP), Asynchronous Transfer Mode (ATM), Real-time Transport Protocol (RTP), Real-time Streaming Protocol (RTSP), Session Announcement Protocol (SAP), Session Description Protocol (SDP), and Session Initiation Protocol (SIP). A system and method implementing centrally served COIs may be employed in conjunction with numerous other protocols known in the art or developed and operative in accordance with known principles.

As illustrated in FIG. 1, network clients 111-114 may be connected to network 199, enabling two-way point-to-point, point-to-multipoint, or multipoint-to-multipoint data transfer between and among network clients 111-114, as well as with any other clients connected to network 199 or connected to another network which is accessible from network 199. Additionally, network clients 111-114 may be operatively coupled to peripheral devices such as, inter alia, a telephone or wireless telephone (not shown).

In some embodiments, for instance, network clients may be personal desktop or laptop computers, workstations, personal digital assistants (PDAs), personal communications systems (PCSs), wireless telephones, or other network-enabled devices. The scope of the present disclosure is not limited by the form or constitution of network clients 111-114; any apparatus known in the art which is capable of data communication on network 199 is within the scope and contemplation of the invention as described herein.

Generally, a subscriber's access to a network connection is not limited to a particular hardware device, such as a specific network client 111-114. This flexibility is represented in FIG. 1 by network clients 111 and 112, both of which are depicted as being operated by the same subscriber, “Subscriber 1.” By way of example, network client 111 may represent a personal home computer, while network client 112 may represent a workstation at an office. During network sessions, network 199 and VCN server 118 may recognize Subscriber 1 as a unique individual, whether Subscriber 1 is operating network client 111 from home or network client 112 from the office.

VCN server 118 may include computer server hardware, memory, storage media 119, network adapter hardware and software, and the like, which are generally known in the art. In one embodiment, VCN server 118 may be configured to maintain a virtual community network which subscribers may access through network clients 111-114. This functionality may be enabled through data and software instructions resident on VCN server 118, on storage media 119, or at a remote server (not shown). In operation, VCN server 118 may generally function as a “grouping” server as described in detail below. Those of skill in the art will appreciate that VCN server 118 may employ more than a single physical machine, though only one representative block is indicated at reference numeral 118 in FIG. 1 for clarity.

In accordance with one embodiment, VCN server 118 may allow one or more network subscribers to maintain a logical group of entities, or contacts. The term “contact” as used herein may refer to personal friends or family members, business associates, professional services representatives or clients, and the like, as mentioned above; in other words, a contact may be any person, group, or other entity which may be contacted through the communication network 199. Many network subscribers maintain local or private contact lists, and further categorize the entries in such lists. Grouping VCN server 118 may maintain such logical, categorized groups of contacts in one or more data structures referred to herein as Communities of Interest (COIs), as noted above. As used herein, the term “member” refers to a contact or a group of contacts included in a COI.

The grouping functionality may generally enable VCN server 118 to manage processing tasks involving groups of members. In that regard, VCN server 118 may maintain, or have access to, data records and program instructions enabling grouping or group related functions based upon contact information. Examples of types of relevant data records include, but are not limited to, the following: contact name; one or more telephone numbers or domain names; one or more addresses (post office, electronic mail, or IP, for example); and other personal data.

In operation, VCN server 118 may maintain information, data, and executable program logic or software code related to managing the group abstraction. For example, VCN server 118 may conduct processing such as: querying a database for data records associated with one or more individual members in a specified COI; examining and validating member and COI information; and executing or supervising program procedures related to serving members of one or more COIs simultaneously.

By way of example, a network client 111-114 may set up a new COI through program code or firmware instructions residing, for example, on VCN server 118. In response to a request to create such a new group, VCN server 118 may access data records in storage media 119 directly, for example; additionally or alternatively, VCN server 118 may query or otherwise request such data records from a remote server. VCN server 118 may then validate the existence of individual contacts named as members during creation of the new COI; alternatively, VCN server 118 may create a data record for a previously unknown contact and transmit the new contact information to storage media 119 for storage, or request a remote server to create such a data record for a previously unknown contact.

Maintenance of one or more COIs at VCN server 118 may enable value-added services to be applied against the COI in its entirety, or against a subset of the COI (i.e. a group of members comprising more than a single contact). Such value-added services may include, for example, advanced telephony services or other network enhancements such as presence monitoring as set forth in detail below.

In accordance with one embodiment, one or more COIs may be managed at VCN server 118 using a client/server model; such an implementation may allow a user to retrieve data from multiple client points such as network clients 111-114 as described above. The COI information and data records may be stored in storage media 119 on VCN server 118, for example, or at another server which is accessible to VCN server 118. In this arrangement, VCN server 118 may be implemented as a highly available central office grade server employing one or more physical machines, whereas clients may typically be any computer-based device employing a User Interface (UI) or Graphical UI (GUI). Any computer-based device employing an appropriate UI or GUI may be recognized as a suitable network client. Such devices may include, but are not limited to, the devices noted above with reference to network clients 111-114.

In one embodiment, VCN server 118 may employ hardware, firmware instructions, software programming code, or some combination thereof, to implement presence or status monitoring functionality. For example, a dedicated software module may be employed to monitor and to assess the presence or availability of each member of a monitored COI. Similarly, the network activity of any network subscriber may be monitored. Authorized viewers may have access not only to COI member records (i.e. telephone numbers, IP address, and the like, as described above), but also to real-time presence information regarding the network login status, activity, and availability of each COI member.

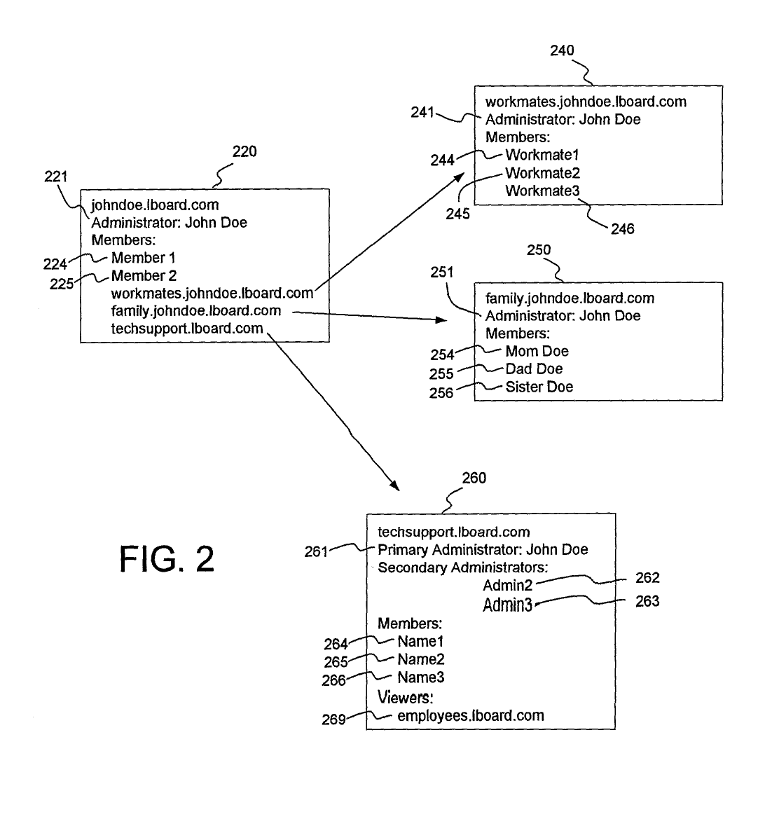

FIG. 2 is a simplified high-level block diagram illustrating embodiments of private and publicly accessible Communities of Interest which may be maintained and served by a Virtual Community Network server. The structure and composition of exemplary COIs are represented by reference numerals 220, 240, 250, and 260 in FIG. 2.

By way of example and with reference to both FIGS. 1 and 2, a network subscriber may use a network client 111-114, for instance, to create and to update COI 220 on VCN server 118. In this embodiment, COI data may be transmitted to VCN server 118 for storage and maintenance, for example in storage media 119. Additionally, a subscriber, through network client 111-114, may request COI information and data records from VCN server 118 in order to view, edit, prioritize, or otherwise to manage COI members' profiles and other data records.

As indicated in FIG. 2, the composition of COI 220 may include individual members 224 and 225, as well as other COIs such as 240, 250, and 260. Such a membership arrangement provides an hierarchical structure similar to a directory tree, as is generally known in the art. A simple COI 240 or 250, for example, may contain only individual members 244-246 and 254-256, respectively. In a more complex embodiment, on the other hand, COI 220 may contain one or more individual members 224, 225 and one or more COIs 240, 250, and 260 (which, in turn, may contain individual members and additional COIs as discussed above).

In one embodiment, each COI may be named to ensure uniqueness across multiple VCN servers. By way of example, a COI name or identifier may include, among other identifying information: the hosting VCN server's domain name; the name of the subscriber who created the COI; and the name or identifying string assigned to the COI by the creating subscriber. Such a system of nomenclature may appropriately limit the possibility of multiple COIs having identical names. By way of example, COI 220 has been named “johndoe.lboard.com” and COI 260 has been named “techsupport.lboard.com” by the creating subscriber.

A network subscriber may have a single “root” COI containing all of that subscriber's COI information. Appropriate COI information may be transmitted to the client when the subscriber initiates a network session with the VCN server and requests COI data. In this manner, a given subscriber may gain access to root COI information, and may additionally or alternatively be able to update membership in the COI, for example, through use of explicit update commands.

In the exemplary embodiment illustrated in FIG. 2, John Doe, a VCN subscriber, maintains a root COI 220, which contains three other COIs (namely, private COIs 240 and 250, and publicly accessible COI 260) as members. It should be noted that the number and composition of COIs (either public or private) which may be maintained within the membership of any given COI need not be constrained in any way; relatively simple membership lists are illustrated in FIG. 2 for clarity only, and are not intended to be construed in any limiting sense.

In the case of private COIs 220, 240, and 250, data records and other information content related to contacts and other entities (such as other COIs) in the membership lists are available only to the administrator 221, 241, and 251, respectively. With respect to private COIs, the administrator may generally be the network subscriber responsible for creating the COI.

Similarly, the primary administrator 261 may generally be the network subscriber responsible for creating public COI 260 (named techsupport.lboard.com). In the case of public COI 260, however, data records and other information content may be made available to secondary administrators and viewers, i.e. certain specified individuals or groups of individuals such as other COIs, for example. The information and data records maintained by the system concerning each member in COI 260, for instance, may be accessible for viewing by the primary administrator 261 as well as secondary administrators 262 and 263. In addition, all members of the employees.lboard.com COI 269 have been granted viewing access to the data content of public COI 260. In the case where a network subscriber is a member of COI 269, then permission or authorization to view the contents of publicly accessible COI 260 follow from the affiliation with COI 269.

A primary administrator 221, 241, 251, and 261 may have the ability to modify the list of members as well as the list of viewers authorized to access the administered COI. For example, primary administrator 261 may modify the list of authorized viewers of COI 260 by adding one or more additional COIs or individual network subscribers, or by removing COI 269. Similarly, primary administrator 261 may add or remove individuals or COIs from the list of members. Additionally, primary administrator 261 may modify the list of secondary administrators, and in this way may be distinguished from a secondary administrator. In other words, secondary administrators 262 and 263 may be authorized to perform substantially all of the functions available to primary administrator 261, with the exception of modifying the list of secondary administrators. In one embodiment, for example, the primary administrator and any secondary administrators may edit, update, or otherwise manipulate both the list of members as well as the list of authorized viewers for a given COI.

It will be appreciated that each member depicted in FIG. 2 represents one or more data records containing selected contact information associated with the member. Such data records may include address information, telephone or facsimile numbers, e-mail address data, domain names, and the like.

As noted above, additional information concerning each member of a COI may be maintained and modified dynamically during operation of a system and method of serving COIs. Such real-time information may generally relate to the network status of each member in the COI, and may be updated in accordance with current network activity, or inactivity, for example. In embodiments employing such presence monitoring functionality, administrators and viewers may be apprised of the availability of various COI members, and may direct communications accordingly, i.e. to members known to be logged on to the network and currently available.

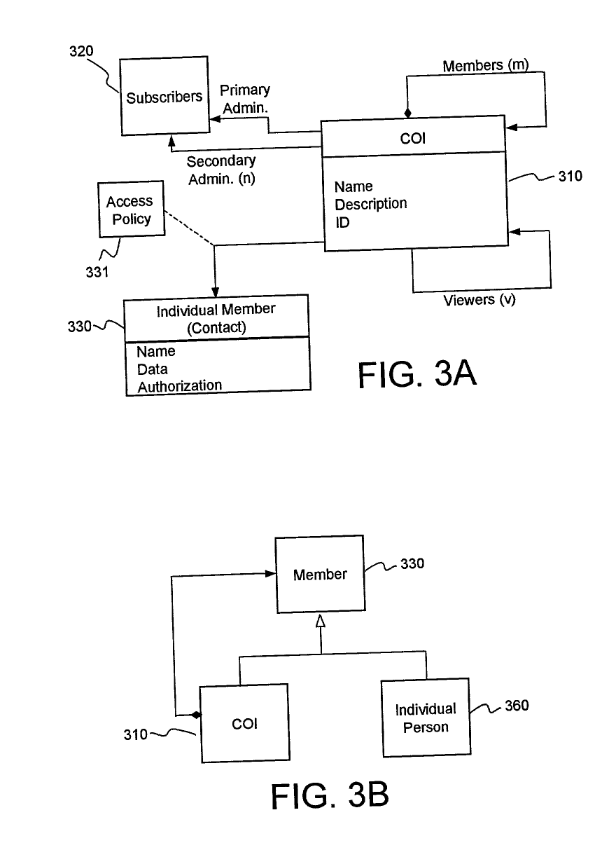

FIGS. 3A and 3B are simplified high-level block diagrams illustrating the general relationship between elements of one embodiment of a Community of Interest.

As depicted in FIGS. 3A and 3B, a COI 310 maintained at a VCN server generally comprises one or more members 330; as discussed above with reference to FIG. 2, a member 330 may be an individual contact 360 or another COI 310. The number, m, of members 330 in a given COI 310 may vary dynamically as new members are added or current members are removed by one or more administrators.

A member 330 generally may be assigned the following: a unique name attribute for identification purposes; a data attribute representing various contact information for the member; and an authorization attribute which may be dictated by an access policy 331, for example. In one embodiment, the name and authorization attributes may combine to ensure that a particular member is not included in a COI more than once; it will be appreciated that a particular individual person or contact may be included as a member in a COI more than once if that contact is assigned more than one unique name (such as, for example, “member1office” and “member1home”) for membership purposes. In other words, more than one member of a COI may be created to represent the same individual contact, but each member entity may generally be treated as unique by the VCN server.

Additionally, COI 310 may also include one or more viewers having access to COI data records stored at the VCN server; additionally, such viewers may have access to COI member presence information maintained at the server-side of the system. As with members, the number, v, of authorized viewers of a particular COI may vary; for example, an administrator may modify the list of viewers as described above, selectively granting or terminating viewing privileges for subscribers. As described above with reference to COI 260 in FIG. 2, a set of viewers may include individual network subscribers as well as an entire COI.

With reference to FIG. 3A, in particular, it should be noted that a member of a COI need not be a subscriber 320 to the VCN server-based system maintaining the COI; specifically, a contact designated as a member of a COI may be any person who may be contacted through a network. In the FIG. 3A embodiment, however, a primary administrator and one or more secondary administrators (as discussed above) are indicated as subscribers 320 to the VCN server system. COI 310 may include only a single primary administrator; in an alternative embodiment, a particular COI may include more than one primary administrator. In the case where multiple administrators are desirable, one or more secondary administrators may be provided. As generally represented in FIG. 3A, the number, n, of secondary administrators may be variable; the list of secondary administrators may be selectively modified, for example, by a primary administrator.

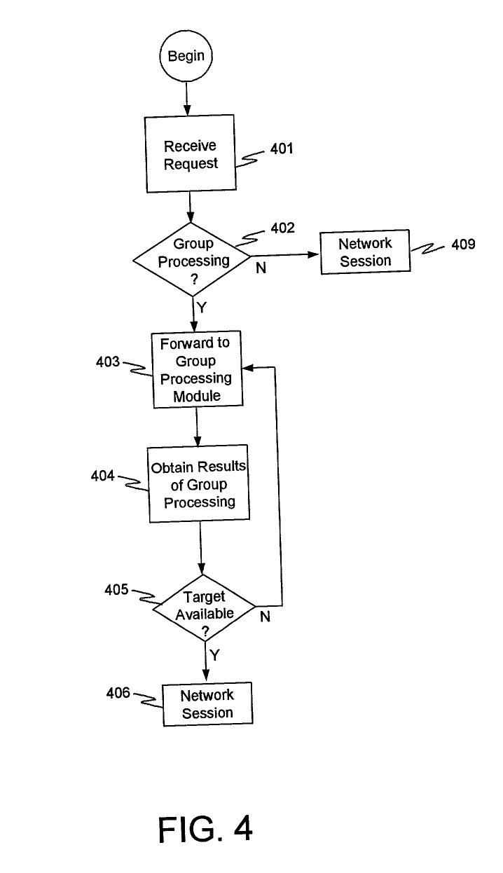

FIG. 4 is a simplified flow diagram illustrating the general operational flow of one embodiment of a method of serving Communities of Interest in a Virtual Community Network environment. As indicated at block 401, a system and method of serving COIs may initially receive an incoming request originating, for example, from a network client. In the exemplary embodiment of FIG. 4, such a request may be related to initiating network communications among one or more contacts, for example, or for updating a particular software program installed at one or more network client computers. Those of skill in the art will appreciate that any number of network-based applications may be served to COIs in a manner which generally follows the basic operational flow modeled in FIG. 4.

In some embodiments, an incoming request may include data packets directed to a grouping server such as VCN server represented by reference numeral 118 in FIG. 1. Alternatively, data packets may be directed to a remote server and routed to a grouping VCN server for analysis. At decision block 402, incoming data packets may be examined to determine if any group processing is required to initiate or otherwise to process the network communication. For example, data packet header information may be parsed to ascertain recipient address information. Such address information may identify one or more intended recipients of the data packet. A recipient may be a COI, for example; in such an instance, group processing may be required to identify data records and to confirm address information associated with one or more members of the COI.

Where no such group processing is required or desired, an invitation may be sent to a specific recipient, and the network communication may simply be initiated as indicated at block 409. Where group related or COI processing is required, however, group processing functionality may be invoked at block 403; any required group related processing tasks may be forwarded, for instance, to group processing hardware or to specialized software programs or firmware instructions.

Results of group processing may then be obtained, as indicated at block 404. The results of COI processing may be a resolution of a group request which identifies a specific COI member for network communication; alternatively, the whole COI, or a subset thereof comprising more than one member, may be treated as a unit for the duration of the network transaction. The results referenced in block 404 may be any other group related information required by the particular network transaction.

Necessary group information regarding the intended recipients of a network transaction (obtained at block 404, for example) may then be used to identify one or more targets for the data communication; a grouping server, for example, or some combination of server hardware components, may identify the target recipient or recipients.

As noted above, a method of serving publicly accessible COIs may include or invoke presence monitoring functionality, for example, to determine the availability of the identified target; this determination is represented in the FIG. 4 embodiment at decision block 405. By way of example, the target may not be logged on to the system at the time of the request for network connection; alternatively, the target may be logged on to the system, but may be engaged in other network activity or otherwise unavailable. In such instances, the grouping functionality may be invoked again as indicated by the loop back to block 403; an alternative group result may be provided at block 404, for example, by setting a flag associated with the unavailable target. That is, a system and method of serving COIs may dynamically alter data records associated with each contact to ensure that a known unavailable target will not be identified at block 404.

Where a target has been identified and further determined to be available, a COI serving method may then initiate network communication (as indicated at block 406 in FIG. 4) from the original client to the identified available target. As noted above, multiple targets may be identified, depending upon the results of any group processing at blocks 403-405.

Those of skill in the art will appreciate that various alternatives to the FIG. 4 embodiment may be possible. For example, the relative locations of block 404 and decision block 405 may be reversed. In this alternative embodiment, results of group processing activity may not be returned until independent processing procedures or routines have confirmed availability of one or more targets. In another alternative embodiment, for example, the foregoing presence monitoring functionality may involve apprising the network client from which the request originated of the real-time network status and availability of each COI member. The requesting network client may then direct the request to a COI member known to be available at the time the request is made; in such an alternative embodiment, an available target may consistently be identified during the first iteration at block 405.

Several aspects of the present invention have been illustrated and described in detail with reference to particular embodiments by way of example only, and not by way of limitation. Those of skill in the art will appreciate that various modifications to the disclosed embodiments are within the scope and contemplation of the invention. Therefore, it is intended that the invention be considered as limited only by the scope of the appended claims.

What is claimed is:

1. A method of serving groups of contacts in a communications network; said method comprising:
maintaining contact data records related to a plurality of network contacts;
generating presence information related to the availability of one or more of said plurality of network contacts;
delivering said presence information to one or more network subscribers; and
initiating data communication between at least one of said network subscribers and one or more of said plurality of network contacts in accordance with said presence information.

2. The method of claim 1 wherein said maintaining includes maintaining a database comprising network address information related to each of said plurality of network contacts.

3. The method of claim 1 wherein said maintaining includes creating a community of interest comprising members representing selected contact data records.

4. The method of claim 1 wherein said generating includes monitoring network activity of said one or more of said plurality of network contacts.

5. The method of claim 1 wherein said delivering is responsive to a request from said one or more network subscribers.

6. The method of claim 1 wherein said delivering includes apprising said one or more network subscribers of the network status of said one or more of said plurality of network contacts.

7. The method of claim 1 wherein said initiating includes identifying ones of said plurality of network contacts as available targets.

8. The method of claim 7 wherein said initiating includes establishing data communication with one or more of said available targets.

9. The method of claim 3 wherein said initiating includes establishing data communication with each of said members in said community of interest.

10. A system comprising:
a computer server executing basic network communication processing tasks;
a grouping server executing group related processing tasks and returning results to said computer server; and
a presence monitoring module monitoring network activity of a plurality of network contacts and providing presence information related to said network activity to said grouping server.

11. The system of claim 10 wherein said grouping server is responsive to requests from said computer server.

12. The system of claim 10 wherein said computer server is operative to receive data packets, to identify one or more intended recipients of said data packets, and to transmit identifying information associated with said one or more intended recipients to said grouping server, and wherein said grouping server, apprised of said identifying information and said presence information, is operative to identify available ones of said one or more intended recipients.

13. The system of claim 12 wherein said grouping server is operative to identify ones of said one or more intended recipients as members of a community of interest.

14. The system of claim 13 wherein said grouping server is operative to resolve a group request to one target selected from said members of said community of interest.

15. The system of claim 14 wherein said computer server is operative to initiate network communications involving said target.

16. The system of claim 13 wherein said grouping server is operative to identify more than one of said members of said community of interest as targets.

17. The system of claim 16 wherein said computer server is operative to initiate network communication involving ones of said targets.

18. The system of claim 13 wherein said computer server is operative to initiate network communication involving all of said members of said community of interest.

19. A server-based communication processing system comprising:
a communication processing server, having data and a communication processing engine residing thereon, identifying one or more intended recipients of a data transmission and executing basic data transmission processing tasks;
a grouping server, having data and a presence monitoring module residing thereon; said presence monitoring module generating presence data related to network activity of said one or more intended recipients, and said grouping server receiving group related processing requests from said communication processing engine; and
a contact database having data records stored therein, said data records containing information associated with said one or more intended recipients and accessible to said grouping server.

20. The system of claim 19 wherein said grouping server is operative to resolve a group request to a single target selected from said one or more intended recipients in accordance with said presence data.

21. The system of claim 20 wherein said communication processing engine initiates a data transmission involving said target.

22. The system of claim 19 wherein said grouping server is operative to identify more than one available target selected from said one or more intended recipients in accordance with said data records and said presence data.

23. The system of claim 22 wherein said communication processing engine initiates a data transmission involving said more than one available target.

24. The system of claim 19 wherein said grouping server is operative to maintain at least one community of interest comprising selected data records stored in said contact database.

25. A computer-readable medium encoded with data and computer executable instructions for serving communities of interest; the data and instructions causing an apparatus executing the instructions to:
receive a data transmission directed to one or more intended recipients;
acquire presence information related to the network activity of said one or more intended recipients;
determine whether said data transmission requires group processing;
provide group related processing results in accordance with said presence information; and
initiate data communication in accordance with said group related processing results.

26. The computer-readable medium of claim 25 further encoded with data and instructions, further causing an apparatus to examine address information associated with said one or more intended recipients to identify a group.

27. The computer-readable medium of claim 25 further encoded with data and instructions, further causing an apparatus to resolve a group request to a single target recipient based upon said presence information.

28. The computer-readable medium of claim 25 further encoded with data and instructions, further causing an apparatus to identify a plurality of said one or more intended recipients as members of a community of interest.

29. The computer-readable medium of claim 28 further encoded with data and instructions, further causing an apparatus to establish data communication with each of said members of said community of interest.

30. A system serving communities of interest in a communications network; said system comprising:
a communication processing server, having data and a communication processing engine residing thereon, identifying one or more intended recipients of a data transmission and executing basic data transmission processing tasks;
group processing means for executing group related processing tasks responsive to instructions from said communication processing server;
a contact database having data records stored therein, said data records containing information associated with said one or more intended recipients and accessible to said group processing means; and
monitoring means for monitoring network activity of said one or more intended recipients, generating presence information related to said network activity, and communicating said presence information to said group processing means.

31. The system of claim 30 wherein said communication processing engine is operative to accept data packets having address information related to said one or more intended recipients.

32. The system of claim 30 wherein said group processing means is operative to resolve a group request to a single target recipient selected from said one or more intended recipients in accordance with said presence information.

33. The system of claim 30 wherein said group processing means is operative to identify ones of said one or more intended recipients as members of a community of interest.

34. The system of claim 33 wherein said communication processing engine is operative to initiate data communication involving each of said members.

35. The system of claim 30 wherein said communication processing server and said group processing means cooperate to maintain a community of interest comprising selected data records stored in said contact database.

36. The system of claim 35 further comprising means for selectively altering said selected data records in said community of interest.

37. The system of claim 35 further comprising means for transmitting said selected data records in said community of interest to network subscribers.

38. The system of claim 35 further comprising means for transmitting said presence data to network subscribers.

39. The system of claim 33 further comprising means for transmitting said presence data related to said members to network subscribers.
